(19) United States
(12) Patent Application Publication
(10) Pub. No.: US 2004/0168204 A1
(43) Pub. Date: Aug. 26, 2004

(54) Method of processing packet data between video server and clients

(76) Inventor: Hun Choe, Seo-gu (KR)

Correspondence Address: HARNESS, DICKEY & PIERCE, P.L.C., P.O. BOX 828, BLOOMFIELD HILLS, MI, 48303, US

(21) Appl. No.: 10/746,479

(22) Filed: Dec. 24, 2003

(30) Foreign Application Priority Data
Dec. 26, 2002 (KR) 2002-84028

(51) Int. Cl. H04B 1/66; H04N 7/12; H04N 11/02; H04N 11/04; H04N 7/16; H04N 7/00; H04N 11/00

(52) U.S. Cl. 725/135; 375/240.13; 725/136; 348/461; 348/468; 725/138

(57) ABSTRACT

The present invention relates generally to a method of processing packet data between a video server and clients, and more particularly to a method of transmitting packet data to a plurality of clients related to different data rates from a video server that employs a real-time moving image compression method. In the method of processing packet data between a video server and a plurality of clients of the present invention, the video server is implemented as a moving image compression video server including a camera, an image acquiring unit, a moving image compressor, a stream server and a network interface, and the clients are connected to the video server through different paths. In the method, the stream server divides compressed image data, which has been read from the moving image compressor, into packets and buffers the packets in at least one packet buffer provided in the stream server, before transmitting the compressed image data to the network interface. The packet buffer assigns pointers for indicating positions of packets to be transmitted, and socket buffers of the network interface to which packet information at positions indicated by the pointers is copied and transmitted.

### BACKGROUND OF THE INVENTION

1. Field of the Invention

The present invention relates generally to a method of processing packet data between a video server and clients, and more particularly to a method of transmitting packet data to a plurality of clients related to different data rates from a video server that employs a real-time moving image compression method.

2. Description of the Related Art

With the development of the Internet, a user can access the Internet at high speeds at home and, then, view traffic conditions as well as Internet television (TV) programs and movies in the form of moving images.

Further, a user can monitor, in real-time, the conditions of children staying in a kindergarten or orphanage in the form of moving images through the Internet.

These functions are possible because a moving image compression video server is installed to connect to the Internet and users can access the moving image compression video server through clients (computers) to receive picture data from the moving image compression video server.

Such a moving image server is classified into two types: one in which recorded moving image data is previously compressed/stored, and then transmitted at the request of a client, and the other in which moving image data is compressed and transmitted in real-time.

In the case where moving image data is previously compressed and transmitted, data rates at which data are transmitted to respective clients are divided into several categories, and bit streams corresponding to the categories are separately stored to enable the users of the clients to select one from the categories.

In this case, a moving image compression method is mainly used to increase compressibility.

However, a video server that compresses moving image data in real-time generally adopts a still image compression method requiring a relatively short compression time. In this case, the transmission is generally performed in the way that some frames are skipped depending on data rates at which data are transmitted to respective clients through the network.

The present invention, which will be described later, relates to a method of transmitting packet data to a plurality of clients related to different data rates from a video server that uses the above real-time moving image compression method.

FIG. 1 is a schematic diagram showing a relationship between a typical video server and clients.

As shown in FIG. 1, a plurality of clients 103a, 103b, . . . , 103n are connected to a video server 101 through a network 102 and receive video data from the video server 101.

In this case, the respective clients are separately connected to the video server, so that respective paths differ.

Due to the difference in paths to the network 102 separately constructed in this way, the data rates of the respective clients differ.

Further, each of the clients 103a, 103b, . . . , 103n generally generates a response signal (that is, a message transmitted from the client to the video server and indicating that the client safely receives data and is ready to receive other data) in response to video data received from the video server 101. A response time (from a time when the video server transmits data to a time when the video server receives a response signal from a corresponding client) differs according to the states and processing speeds of the clients.

In this way, differences occur in the data rates between the respective clients 103a, 103b, . . . , 103n and the video server 101 due to the differences between the respective clients 103a, 103b, . . . , 103n and paths thereto.

As described above, in the case where the data rates between the respective clients and the video server 101 are different, the video server 101 employing a still image compression method as shown in FIG. 2 generally excludes a part of the images of 30 frames per second and transmits the remaining images except for the excluded part.

This transmission method uses the characteristics of the still image compression method. In the case of still images, the number of bits per frame does not differ greatly according to frames. Further, if one frame is excluded, the number of bits can be reduced in proportion to the excluded frame.

That is, since the number of frames is directly proportional to the number of bits, the number of frames is controlled to cope with the rate of the network 102.

In the case of the first client 103a related to a high network rate, all frames can be transmitted, like frames 1, 2, 3, 4, 5, 6, 7, . . . , to the first client 103a. Further, in the case of the second client 103b related to a low network rate, frames are transmitted, like frames 1, 4, 7, . . . , while some frames are skipped over.

In the case of the video server using the still image compression method as shown in FIG. 2, respective frames are independently compressed. All frames can be regarded as intra-frames from a standpoint of the moving image compression method of FIG. 3.

However, in the case of the video server 101 employing the moving image compression method as shown in FIG. 3 and using a single video compressor, it is impossible to transmit different frames to the respective clients 103a, 103b, . . . , 103n due to the difference in compression method.

That is, it is impossible to transmit frames 1, 3, 5, to the second client 103b while transmitting frames 1, 2, 3, 4, 5, 6, . . . , to the first client 103a.

A reason for this is that the compression of moving images is performed through the compression between frames, in which a current frame cannot be decoded only using compressed data thereof, but decoded using a frame just previously decoded, as well as the compressed data.

That is, if frames 1, 2, 3, 4, 5, 6, 7, . . . are sequentially compressed, a decoder requires a decoded frame 2 to decode the frame 3.

Therefore, it is impossible to precisely decode frames transmitted except for the frame 2.

Even in the case of the real-time moving image compression method, all frames are not compressed through the compression between frames, but compressed while intermittently employing the still image compression method by reason of error correction and other operations.

Such a frame to which the still image compression is applied is designated as an intra-frame I, and the remaining frame is designated as an inter-frame P.

The intra-frame I is independently compressed using only a current frame, and the inter-frame P is compressed with a correlation between current and previous frames taken into account.

The intra-frame I is independently decoded using only the frame itself. The video server 101 employing the moving image compression method intermittently inserts intra-frames I into the frames, thus transmitting the frames to low data rate-related clients in the way that the inter-frames P between the intra-frames I are skipped.

However, an intra-frame I has the amount of data greater than an inter-frame P.

That is, the number of bits of the intra-frame I is relatively greater than that of the inter-frame P to such an extent that the number of bits of the intra-frame I is several times to several tens of times that of the inter-frame P.

However, if it is predicted that low data rate-related clients exist, and then intra-frames I are intermittently inserted into frames, a bad influence may be actually given to the rate of the network 102.

If there are no intra-frames I, a problem may occur in which low data rate-related clients intermittently receive compressed data when decoding frames along the inter-frames P.

### SUMMARY OF THE INVENTION

Accordingly, the present invention has been made keeping in mind the above problems occurring in the prior art, and an object of the present invention is to provide a method of processing packet data between a video server and clients, which improves the rate of a network and does not badly influence the compression quality of an image by reducing the number of generated intra-frames for the benefit of low data rate-related clients, thus efficiently utilizing network resources.

In order to accomplish the above object, the present invention provides a method of processing packet data between a video server and a plurality of clients, the video server implemented as a moving image compression video server including a camera, an image acquiring unit, a moving image compressor, a stream server and a network interface, the clients being connected to the video server through different paths, the method comprising the steps of the stream server dividing compressed image data, which has been read from the moving image compressor, into packets and buffering the packets in at least one packet buffer provided in the stream server, before transmitting the compressed image data to the network interface; and the packet buffer assigning pointers for indicating positions of packets to be transmitted, and socket buffers of the network interface to which packet information at positions indicated by the pointers is copied and transmitted.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a relationship between a video server and clients;

FIG. 2 is a view showing a compressed still image frame sequence;

FIG. 3 is a view showing a compressed moving image frame sequence;

FIG. 4 is a configuration diagram of a video server according to the present invention;

FIG. 5 is a configuration diagram of packets according to the present invention;

FIG. 6 is a detailed configuration diagram of a stream server of FIG. 4; and

FIG. 7 is a flowchart of a method of managing a packet pointer and generating an intra-frame according to the present invention.

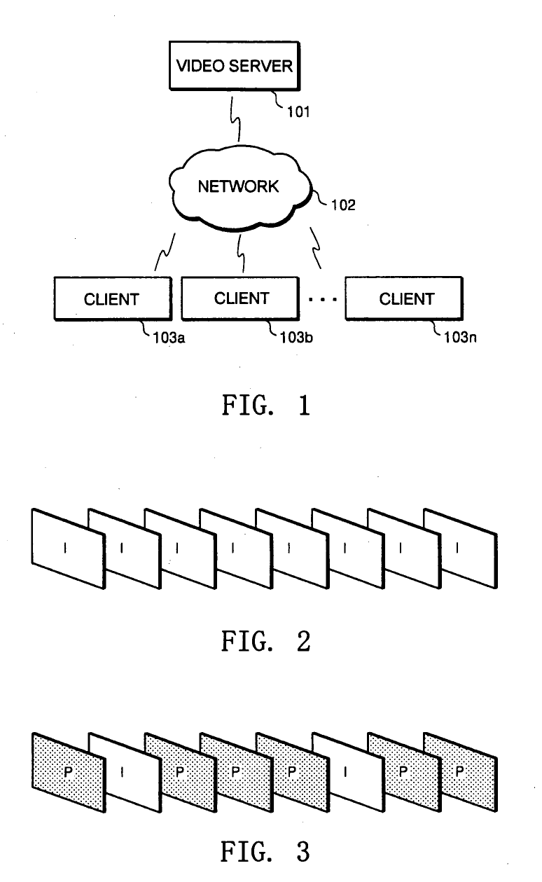

### DESCRIPTION OF THE PREFERRED EMBODIMENTS

Hereinafter, embodiments of the present invention will be described in detail with reference to the attached drawings.

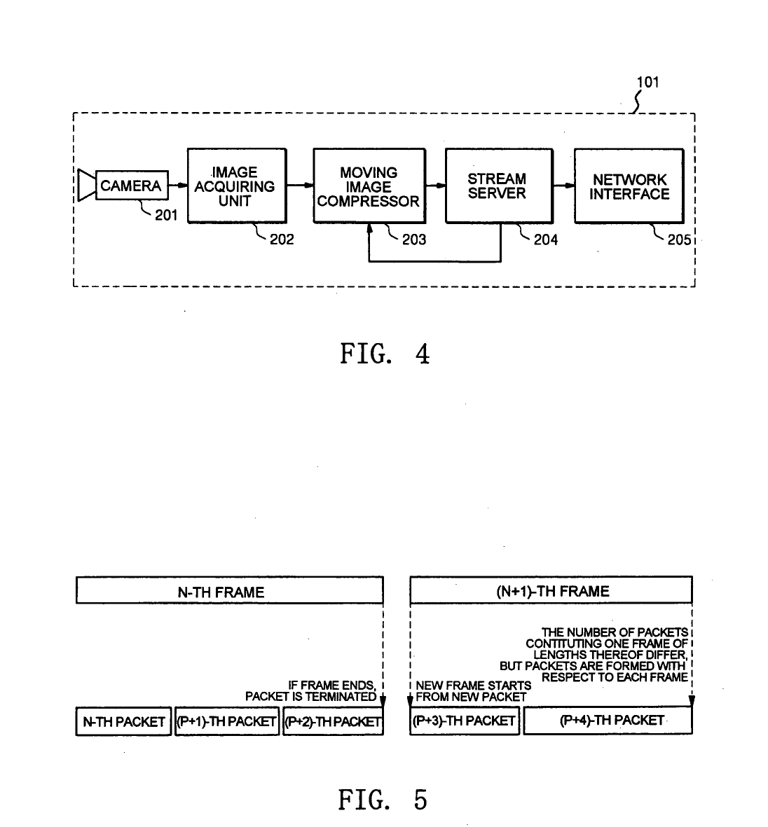

FIG. 4 is a configuration diagram of a video server according to the present invention. The video server 101 includes a camera 201, an image acquiring unit 202, a moving image compressor 203, a stream server 204 and a network interface 205.

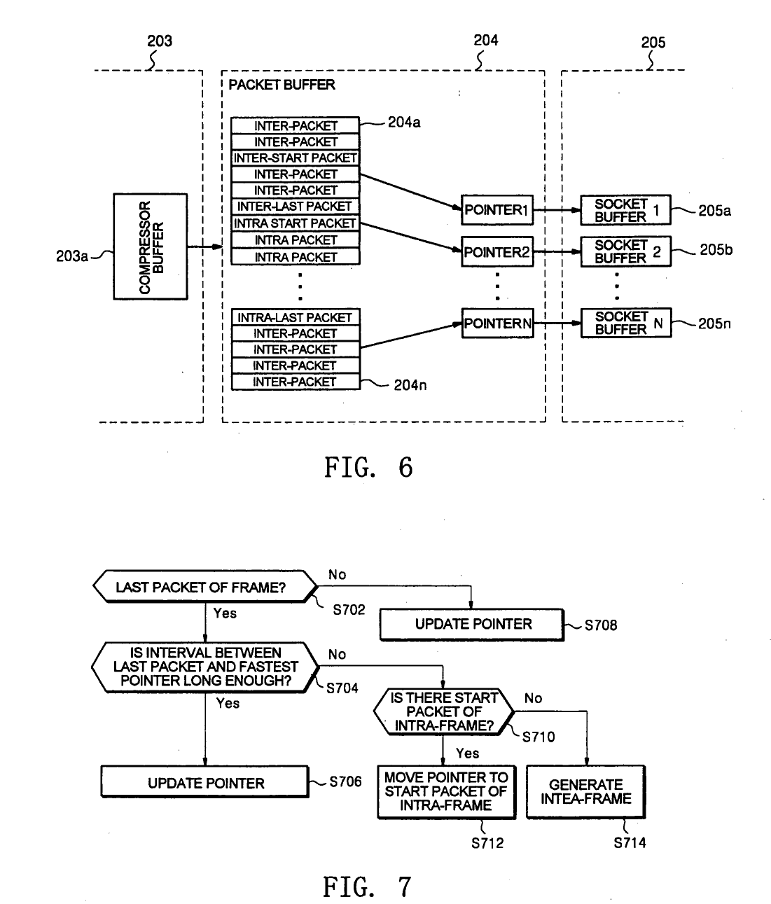

The present invention relates to the stream server 204, the construction of which is depicted in FIG. 6.

As shown in FIG. 6, the stream server 204 divides compressed image data, which has been read from a compressor buffer 203a of the moving image compressor 203, into packets before transmitting the compressed image data to the network interface 205. The packets generated at this time are formed with respect to each of the frames.

Further, as shown in FIG. 5, one frame can be transmitted as one or more packets. A corresponding packet is terminated by the end of each frame, so packets can be managed with respect to each frame.

As shown in FIG. 6, the packets are stored in packet buffers 204a, 204b, . . . , 204m, which assign pointers for indicating the positions of packets to be transmitted by the packet buffers, and socket buffers 205a, 205b, . . . , 205n of the network interface 205 to the respective clients for the benefit of the clients.

That is, information on packets indicated by respective pointers is copied to the socket buffers of the network interface 205 and then transmitted. At this time, the movement speeds of the pointers are proportional to the data rates at which data are transmitted to the respective clients.

The packet buffers 204a, 204b, . . . , 204m form a cyclic buffer, so that each pointer returns to the position of the first packet buffer 204a after the value of each pointer is increased by a certain number m.

The contents in the packet buffers are updated to newly generated packet data according to the speed of a fastest pointer. The fastest pointer outruns a slow pointer to cause data errors at a low data rate-related client.

In order to prevent the data errors, a slow pointer must skip to another packet position before a faster pointer approaches a current packet position. At this time, the position to which the slow pointer skips becomes a start packet of an intra-frame.

If there is no start packet of an intra-frame in front of the slow pointer, an intra-frame is compulsorily generated.

Further, a pointer for a low data rate-related client stops and then transmission to the client stops while the intra-frame is generated.

In this case, a packet, previously indicated by the slow pointer before skipping, must be a last packet of a frame.

FIG. 7 is a flowchart of a method of increasing (updating) a packet pointer of a client, moving the position of the packet pointer and generating an intra-frame.

If a large number of intra-frames are unnecessarily generated, an excessive load is applied to the network. Therefore, the load of the network must be reduced by minimizing the number of intra-frames to such an extent that errors are corrected.

For this operation, the present invention performs the determination of FIG. 7 whenever a pointer of each client is increased (updated) while a last packet of a frame is transmitted.

First, the stream server 204 determines whether a current packet indicated by a current pointer is a last packet of a frame at step S702. If the current packet is the last packet, the stream server 204 determines whether an interval between the last packet and a fastest pointer is long enough at step S704.

If the interval is long enough, the current pointer is updated because there is no concern that the fastest pointer outruns a slow pointer to cause data errors at a low data rate-related client at step S706.

If the interval is not long enough, the stream server 204 determines whether a start packet of an intra-frame exists in front of a slow (current) pointer because there is a concern that a fastest pointer outruns the current pointer to cause data errors at the low data rate-related client at step S710. If the start packet of the intra-frame exists, the current pointer moves (skips) to the start packet of the intra-frame at step S712.

If a start packet of an intra-frame does not exist at step S710, the stream server 204 requests the moving image compressor 203 to generate an intra-frame, and then the moving image compressor 203 generates an intra-frame at step S714.

If the current packet is not a last packet at step S702 for determining whether the current packet is a last packet of a frame, the current pointer is updated at step S708.

In this way, an unnecessary intra-frame is prevented from being generated.

The generation of the intra-frame does not frequently occur when a difference between the data rates of clients is not large. In the case where a difference between the data rates of the clients is large and one video server supports a great number of clients, intra-frames can be more efficiently generated if the clients are classified according to the data rates thereof and organized into several groups, and one moving image compressor is used with respect to each of the groups.

That is, since the data rates of the clients within one group are virtually the same, the number of generated intra-frames is reduced in proportion to the number of clients. Further, each group is regarded as one video server including one moving image compressor under an environment in which a plurality of moving image compressors exist, thus the above-described method can be applied to the environment as it is.

As described above, a video server using a moving image compression method has greater compressibility than a video server using a still image compression method to reduce a load of a network, thus increasing the efficiency of the network.

However, in the case of the moving image compression method, intra-frames must be inevitably inserted into frames for the benefit of the clients related to different data rates. At this time, since the intra-frames have a great amount of data, the number of generated intra-frames must be minimized.

Accordingly, the present invention is advantageous in that the number of generated intra-frames is minimized for the benefit of low data rate-related clients, thus efficiently utilizing network resources.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of processing packet data between a video server and a plurality of clients, the video server implemented as a moving image compression video server including a camera, an image acquiring unit, a moving image compressor, a stream server and a network interface, the clients being connected to the video server through different paths, the method comprising the steps of:
the stream server dividing compressed image data, which has been read from the moving image compressor, into packets and buffering the packets in at least one packet buffer provided in the stream server, before transmitting the compressed image data to the network interface; and
the packet buffer assigning pointers for indicating positions of packets to be transmitted, and socket buffer of the network interface which is packet information of position indicated by said pointers copied and transmitted.

2. A method of processing packet data between a video server and a plurality of clients, the video server implemented as a moving image compression video server including a camera, an image acquiring unit, a plurality of moving image compressors, a stream server and a network interface, and the clients being connected to the video server through different paths, the method comprising the steps of:
organizing groups of clients related to similar data rates by the number of moving image compressors;
the stream server dividing compressed image data, read from each of the moving image compressors, into packets and buffering the packets in at least one packet buffer provided in the stream server, before transmitting the compressed image data to the network interface; and
the packet buffer assigning pointers for indicating positions of packets to be transmitted, and socket buffer of the network interface which is packet information of position indicated by said pointers copied and transmitted.

3. The packet data processing method according to claim 1, wherein the packets are constructed so that they are formed and managed with respect to each of frames, one frame is comprised of one or more packets, and a corresponding packet is terminated on an end data of each frame.

4. The packet data processing method according to claim 3, wherein the assignment of the pointers is performed so that a corresponding pointer is updated at a time when a last packet of one frame is copied to a corresponding socket buffer.

5. The packet data processing method according to claim 3, wherein the assignment of the pointers is performed so that an interval between a current pointer and a fastest pointer is checked where data rates of respective clients are different, and if the interval is not long enough, the current pointer moves to a start packet of an intra-frame closest to a current frame to be updated.

6. The packet data processing method according to claim 5, wherein the assignment of the pointers is performed so that, if there is no start packet of a closest intra-frame, an intra-frame is newly generated.

7. The packet data processing method according to claim 2, wherein the packets are constructed so that they are formed and managed with respect to each of frames, one frame is comprised of one or more packets, and a corresponding packet is terminated on an end data of each frame.

8. The packet data processing method according to claim 7, wherein the assignment of the pointers is performed so that a corresponding pointer is updated at a time when a last packet of one frame is copied to a corresponding socket buffer.

9. The packet data processing method according to claim 7, wherein the assignment of the pointers is performed so that an interval between a current pointer and a fastest pointer is checked where data rates of respective clients are different, and if the interval is not long enough, the current pointer moves to a start packet of an intra-frame closest to a current frame to be updated.

10. The packet data processing method according to claim 9, wherein the assignment of the pointers is performed so that, if there is no start packet of a closest intra-frame, an intra-frame is newly generated.
